(19) United States
(12) Patent Application Publication
(10) Pub. No.: US 2011/0038612 A1
(43) Pub. Date: Feb. 17, 2011

(54) LIVE IMAGES

(75) Inventors: David Evan JOFFE, Tel Aviv (IL); Sharon Mor Yosef, Moshav Bequaot (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: IMAGINE LTD, Tel Aviv (IL)

(21) Appl. No.: 12/540,376

(22) Filed: Aug. 13, 2009

(51) Int. Cl. H04N 5/93; H04N 7/26

(52) U.S. Cl. 386/290; 386/E05.001; 386/229

(57) ABSTRACT

A method and system for displaying content on a display device. The method comprises obtaining one or more sequences of frames having a first frame and a last frame, in which a transformation between the last frame and the first frame is seamless; and repeatedly displaying one of the sequences of frames on the display device.

The system comprises a display device and a player operatively coupled to the display device and adapted to repeatedly play at least one sequence of frames.

The sequence of frames may be encoded with a unique identifier associated with the player or with the display device, so that the sequence can be displayed only on the display device or by the player

### CROSS-REFERENCE TO RELATED APPLICATIONS

The instant application is a continuation-in-art of International Application Serial No. PCT/IL2008/000202 filed on Feb. 14, 2008, which claims benefit of U.S. Provisional Application Ser. No. 60/889,939 filed on Feb. 15, 2007.

### TECHNICAL FIELD

The disclosure relates generally to public presentation of digital media, and in particular to the presentation of digital art brought to life on an electronic screen in an infinite loop.

### BACKGROUND

Digital art exists and is being created in enormous volumes, yet the digital art market is very limited. Some key reasons for this situation include the ease of digital media duplication, which leads to widespread copyright violation, and a lack of a convenient way to store and present quality digital art (especially video) outside of a computer.

The display of digital art images on a TV display (or “screen”) is known in the art. Hereinafter, “screen” is used to represent any type of display capable of displaying a still image or a video sequence. Encoding and decoding of digital art aimed at copyright protection is also known.

None of the known techniques allows presentation of original digital art, including still art converted into “live” video images, in a continuous, infinite loop on a TV screen. Therefore, there is a need for and it would be advantageous to have ways to display digital art on a screen in a way that would turn the screen into a live work of art (also referred to as “live image”).

### SUMMARY

The disclosure discloses methods for exhibiting live images of digital art on a screen in an infinite loop video sequence. In some embodiments, the digital art is a still image (such as a painting) imported into a computer, “brought to life” as a video sequence and exhibited on the screen in an infinite loop. In some embodiments, the live art is a filmed video sequence arranged to form an infinite loop and exhibited on the screen in the infinite loop. The infinite loop is characterized by the fact that the beginning and end of the sequence merge seamlessly, without a cut. In some embodiments, the infinite loop may be achieved by animation added to the still image or to the filmed video sequence.

In some embodiments, the digital art is encoded prior to its download, then decoded for presentation and played as a video stream in an infinite loop on the screen. If the digital art originates from a still image, the video stream includes a series of frames representing live images based on the original still image. The processes for turning of a still image into a live digital art image and its presentation on the TV screen in an infinite loop are described in more detail below. In some embodiments, a player operatively coupled to the screen can receive, decode and play in any conventional format live art to be exhibited only on a specific screen. In some embodiments, the player is incorporated in the screen. In some embodiments, the screen and/or player include a memory and a mechanism to access the memory. In some embodiments, the player may have an optional mode of playing automatically when the screen is turned off.

In some embodiments, there is provided a method of exhibiting art on a screen, including the steps of creating an infinite loop video sequence of the art and exhibiting the infinite loop video sequence on the screen. In some embodiments, the screen is a flat TV screen. In some embodiments, the step of creating an infinite loop video sequence includes filming a video sequence having a beginning and an end, digitizing the video sequence, and editing and optionally animating the video sequence to obtain the effect of the infinite loop. In some embodiments, the editing includes choosing a shot, duplicating the shot and merging the chosen and duplicated shots to form the infinite loop.

In some embodiments, there is provided a method of exhibiting live art on a screen, including the steps of obtaining an art item in digital form creating an infinite loop video sequence of live art from the art item in digital form and exhibiting the infinite loop video sequence as live art on a screen in an infinite loop. In some embodiments, the step of exhibiting the infinite loop video sequence as live art on a screen in an infinite loop includes exhibiting the live art as a unique work of art by allowing the live art to be exhibited only on a particular screen.

In some embodiments, there is provided a system for exhibiting live art on a screen in an infinite loop including a screen and a player operatively coupled to the screen, the player configured to play a video sequence of live art for exhibition in an infinite loop on the screen.

An aspect of the disclosure relates to a method of displaying content on a display device, the method comprising: obtaining one or more sequences of frames having a first frame and a last frame, in which a transformation between the last frame and the first frame is seamless; and repeatedly displaying one of the sequences of frames on the display device. Within the method one or more sequences of frames are optionally encoded with a unique identifier associated with the display device or with a player associated with the display device. Within the method one or more sequences of frames are optionally displayed only on the display device associated with the unique identifier. Within the method the first frame and the last frame of the video sequence are optionally substantially identical. Within the method, the transformation between the frame before the last frame and the last frame optionally leads to the transformation between the last frame and the first frame. The method can further comprise a step of creating one or more of the sequences of frames. Within the method creating a sequence of frames optionally comprises: receiving an image; and creating the sequence of frames such that an object or a part of the image changes between images of the sequence of frames. Within the method, creating the sequence of frames optionally comprises filming by a static camera. Within the method, creating the sequence of frames optionally comprises filming by a dynamic camera or a camera using a dynamic frame size. Within the method, the transformation is optionally made seamless by using a quick camera movement. Within the method, creating the sequence of frames optionally comprises filming a basic sequence of frames comprising a shot having a first frame and a last frame; digitizing the at least one shot; and editing the shot to obtain an effect of seamless transformation between the last frame and the first frame, to obtain the at least one sequence of frames. Within the method, editing the shot optionally comprises: duplicating the shot to obtain a duplicated shot; and merging the end of the shot with the beginning of the duplicated shot. Within the method, merging the end of the at least one shot with the beginning of the duplicated shot is optionally performed using a technique selected from the group consisting of: adding a transition effect; adding a masked wipe effect; adding animated frames between the end of the at least one shot wit the beginning of the duplicated shot; adding another layer of video; and adding a dissolve effect. Within the method the one or more sequence of frames optionally comprises at least two sequences of frames. The method can further comprise a step of selecting a random sequence of frames from the at least two sequences of frames and displaying the random sequence of frames.

Another aspect of the disclosure relates to a system for displaying content on a display device, comprising a display device; and a player operatively coupled to the display device and adapted to repeatedly play one or more sequences of frames. Within the system, a sequence of frames may be created such that the last frame is seamlessly transformed to the first frame. Within the system, the one or more sequences of frames optionally comprise at least two sequences of frames, and wherein the player is adapted to randomly select a sequence of frames to be displayed from the at least two sequences of frames. Within the system the player is optionally adapted to play the sequences of frames, provided that at least one of the sequences of frames has encoded therein a unique identifier associated with the player or with the display device. The system can further comprise a storage device for storing the sequence of frames.

### BRIEF DESCRIPTION OF THE DRAWINGS

The disclosure is herein described, by way of example only, with reference to the accompanying drawings, wherein:

FIG. 1 shows a flow chart of one method embodiment;

FIG. 2 shows a flow chart of another method embodiment;

FIG. 3 shows a flow chart of yet another method embodiment;

FIG. 4 shows a schematic embodiment of a process for creating a seamless transformation between two identical shots in an infinite video sequence;

FIG. 5 shows the process of filming a video sequence for an infinite loop.

FIGS. 6A-G show an example of an art item processed for exhibition as a live art item in an infinite loop on a screen, in various frames of a video sequence.

FIG. 7 shows an embodiment of a system that can be used in the preparation and presentation of the live art images or filmed video sequences in an infinite loop.

### DETAILED DESCRIPTION

As mentioned, the disclosure provides methods for converting any screen, in particular a flat TV screen that may be hanged on a wall, into a “work of art”, by exhibiting live digital art on the screen in one of the particular ways described below.

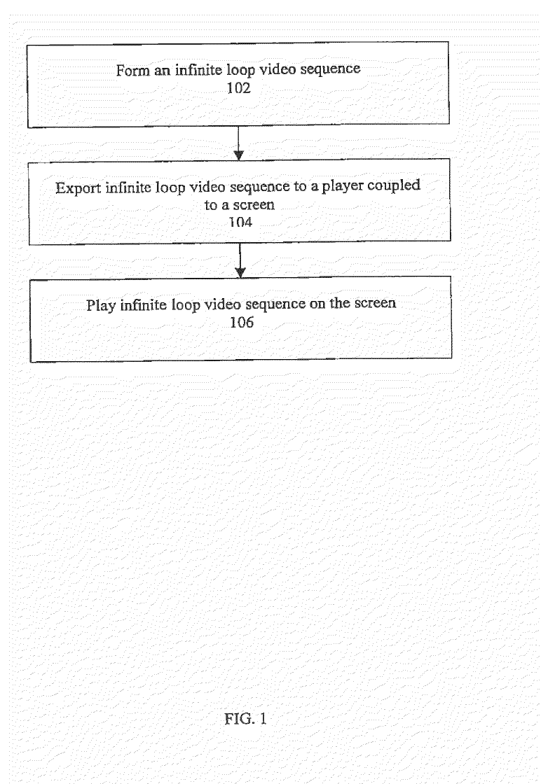

FIG. 1 shows a flow chart of one method embodiment. In this embodiment, an infinite loop (or “looped”) video sequence is formed, by ways described in detail below, in step 102. The infinite loop video sequence is exported to a player capable of playing the looped video sequence in step 104, and the sequence is played in an infinite loop on the screen in step 106. The exported video sequence may be in any type of format suitable to be played, for example AVI, MPEG, Quick-time or Flash file. An exemplary player that may play a looped video sequence in an infinite loop is the Windows Media Player of Microsoft Corporation

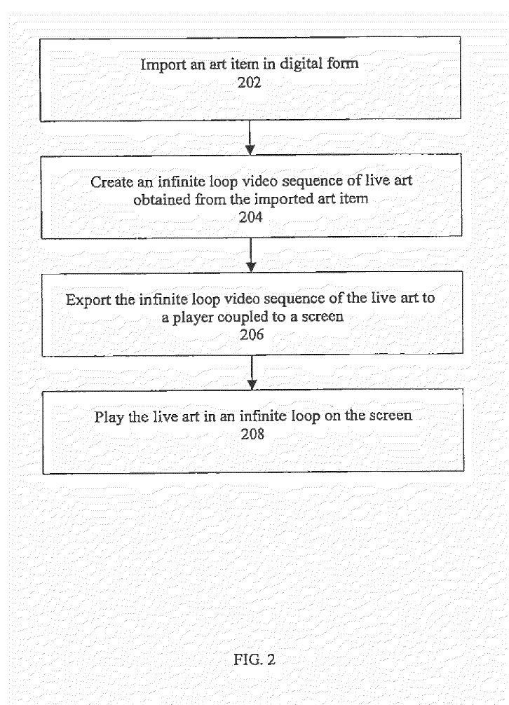

FIG. 2 shows a flow chart of another method embodiment. In this embodiment, a digital art item is brought-to-life and exhibited on a screen as a looped video sequence. The art item may be any work of art that can be converted into digital form, including (but not limited to) a photograph, an etching, a sculpture, a manuscript, etc. The art item is imported in a digital form in step 202. An infinite loop video sequence showing the digital art item as “live art or “live images” is formed from the digital art item in step 204. The infinite loop video sequence of the live images is exported to a player coupled to a screen in step 206, and the live art is shown on the screen in an infinite loop in step 208.

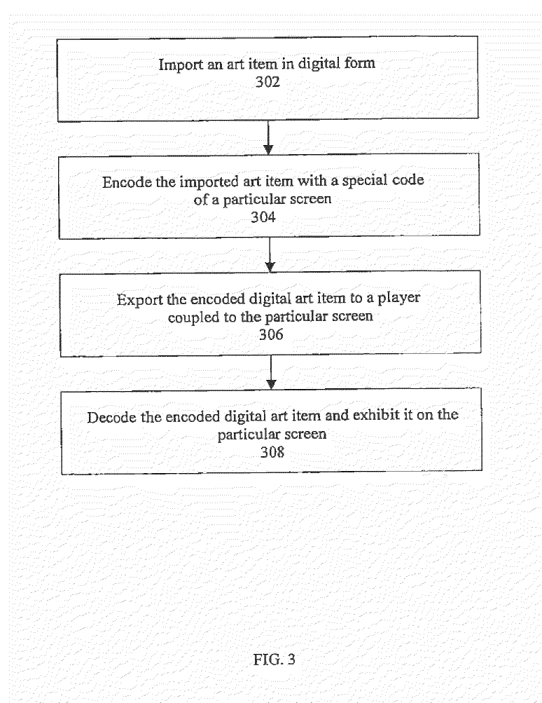

FIG. 3 shows a flow chart of yet another method embodiment. In this embodiment, a live art item is imported in digital form in step 302 and encoded with a unique identifier (ID) in step 304, in order to have it exhibited as a “one-of-a-kind” work of art on a particular screen. The unique ID may be a unique code of player (uniquely associated with a particular screen) or the screen on which the art item is to be exhibited as a one-of-kind art item. Exemplarily, each flat TV screen is known to have such a unique code. The encoded live art item is exported to a player associated with a particular screen in step 306. The player decodes the encoded live art item and exhibits it on the particular screen in step 308. Encoding and decoding to achieve the stated goals may be done in different ways, known in the art

In any embodiment, the live art may be stored in a live art “source” such as a storage device, on a server, on a network or on any other means from which it can be transferred to the player/screen. Exemplarily, the storage device may be a memory device such as a Sansa Take-tv device (manufactured by SanDisk Corporation), either external to, or integrated in the screen. The live art item may be protected or unprotected. If protected (as in the embodiment of FIG. 3), the appropriate unique ID, as described above, may be provided to the source. Alternatively, in some embodiments, the server or the player may detect the unique ID automatically.

### Creating a Looped Video Sequence Based on Video Filming

A video sequence has a beginning and an end. An infinite loop is formed when the sequence is repeated in a way that there is a seamless transfer between repeated consecutive sequences such that no “cut” is felt. This contrasts with known repeated showings of a video sequence on a screens where a cut between the end and a next beginning of the same sequence is always present and clearly felt. The definition of “cut” and the reason why in known art such a cut is always present is explained next.

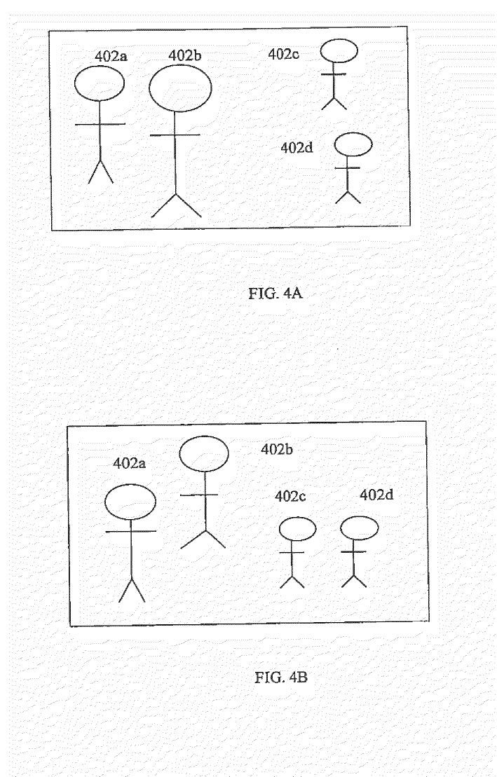

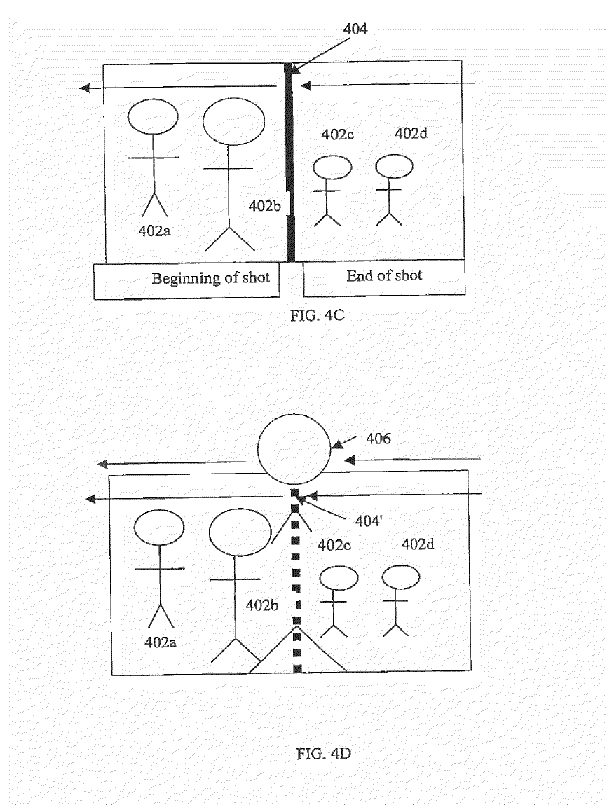

A looped video sequence may be obtained by filming a scene (“shot”). An infinite loop in this case may created by creating an “endless shot” i.e. a shot that one will never really know when it begins and ends, thus creating a feeling of an endless reality that exists beyond the screen. To create a regular loop, the filmed shot is duplicated and the resulting two (identical) shots are joined such that the end of the first shot is followed by the beginning of the duplicated shot. A regular loop thus formed will always have a visible “cut” between the two shots. The cut can appear for a number of reasons, mainly because between the beginning and end of the shot there may be: a) differences in the object filmed; b) differences in lighting; c) a jump in the movement; d) differences in colors, or e) differences in resolutions An endless shot requires that the end of the first shot and the beginning of the duplicate shot undergo a reciprocal transformation without feeling the “cut”. This can be accomplished by either adding a video “dissolve” effect between the beginning and end of the shot or by adding an object in animation that will cover the transformation between the beginning and end of the shot. A specific example of obtaining an effect of endless shot is given with reference to FIG. 4.

FIG. 4 shows schematically a first frame (A) and a last frame (B) of a shot of children 402a-d playing. Note that there may be many other frames (not shown) between these two frames. The normal filming of the shot cannot provide a perfect match (needed for the endless shot illusion) between the beginning of the shot and its end. When the shot is duplicated, the first frame of the duplicated shot is different from the last frame of the first (filmed) shot. Therefore, the match needs to be achieved by extra measures. For example, the match may be achieved by adding a transformation effect such as a “wipe” effect between the two shots. FIG. 4C shows a combined frame with children 402a, b positioned as in the first frame and children 402c, d positioned as in the last frame. A wipe effect is illustrated by a thick black line 404 moving from the right of the frame to the left of the frame, as indicated by arrows. Line 404 need not be black. In order to hide it, an object 406, filmed on a blue screen and entering the combined frame from the right and exiting it on the left (as also indicated by arrows) can be added as a layer above the layer of the wipe, as shown in FIG. 4D. Object 406 and wipe 404 move simultaneously. In the editing room, the blue background of object 406 can be replaced with the shot of the children. Therefore, by overlaying the wipe effect with object 406 one can hide the transition (i.e. wipe) effect (as indicated by the segmented line 404′), hence achieving an endless shot when the sequence is played again and again. In some embodiments, animation may be added to further enhance the transition effect. Exemplarily, the animation may be carried out on a computer using animation software (“animation computer”). The wipe effect and object 406 may perform half of the transition at the end of the edited sequence and the other half at the beginning of the edited sequence. To clarify, in order that the sequence will not “jump” when played by the player, the effect that includes the wipe and the moving object will start at the end of the sequence and finish at the beginning of the sequence.

In some embodiments, the filming of the video sequence may be done using either a static camera or a moving (dynamic) camera and/or a fixed frame size. A filmed object can enter and exit a frame, or can move in a manner that will allow creation of a loop by additional animation. Exemplarily, assume the camera, frame size, background and lighting of the shot are all fixed. The shot includes a plurality of frames. The first frame filmed is a frame without the object. If an object enters the frame from left and exits from right, then enters the frame from right and exits from left, leaving an empty frame again, then the beginning of the shot and the end of the shot will be identical. When playing this shot in a loop, in will seem that the object is in a never-ending movement, entering and exiting the frame.

When both the camera and the frame size are dynamic, a smooth transformation between the beginning of the shot and its end may be achieved as follows: 1) by providing a quick camera movement—e.g. a quick zoom, pan or tilt between the beginning and end of the shot, or 2) by adding animation between the beginning and end of the shot, as explained with reference to FIG. 4.

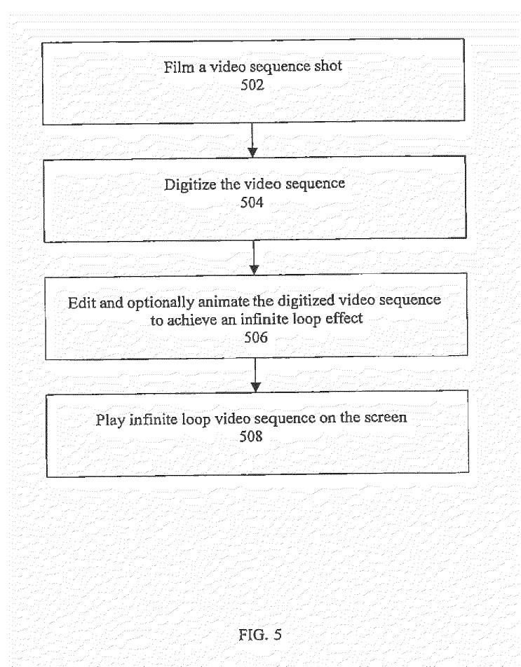

The process of creation of a looped video sequence based on video filming is summarized in FIG. 5. A video sequence is filmed in step 502. The filmed video is digitized to a computer in step 504. The digitized video is then edited and/or optionally animated in step 506. The editing may include choosing the desired shot and duplicating the chosen shot. Optionally, in some embodiments, the editing may also include adding a video effect such as a “dissolve” between the two shots or animation. The editing may further include fixing colors of the original shot by adjusting the contrast of the shot and adding or taking out specific colors and or adjusting the hue and/or luminance of the shot. The edited and/or optionally animated video sequence is then exported to the player (same as step 104 above) and played on the screen in an infinite loop in step 508.

Creating a Looped Video Sequence from a Static Picture

As mentioned in the embodiment of FIG. 2, the video sequence for presentation in the infinite loop on the TV screen may also be obtained from a frame of an art item in digital form (e.g. a painting). The enlivening of the painting and the creation of a looped video sequence of the enlivened painting may be accomplished exemplarily as follows. The frame is transferred to a computer and animated by animation software. Exemplarily, the animation may be done by isolating segments of the static frame and endowing the isolated segments with two dimensional or three dimensional movement, as well known in the art. In order to create the infinite loop effect, the animation may be performed in a manner such that the transformation between beginning and end of the sequence is seamless, as explained above for the filmed video sequence. The video sequence is then exported to the server and from there to the player, to a hard disk, or to an Internet site for downloading to the player.

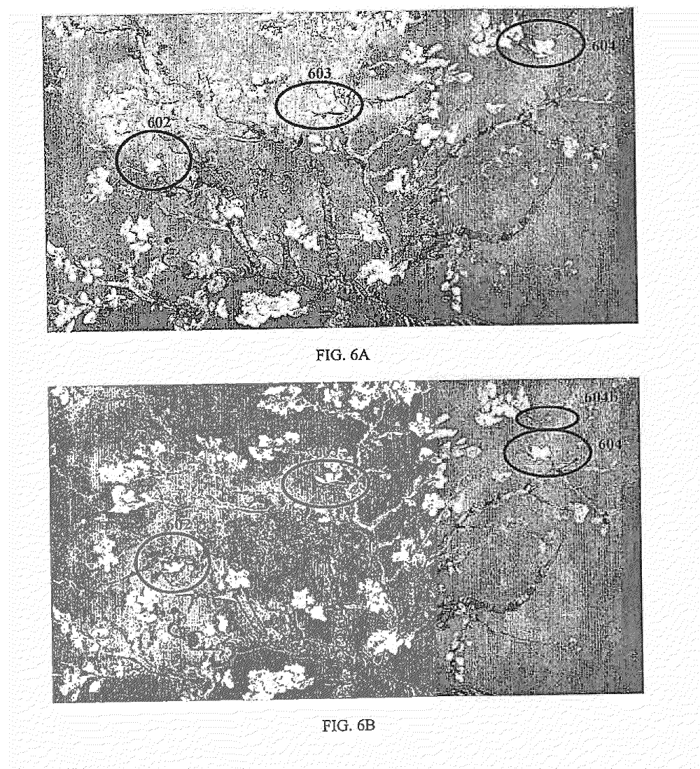

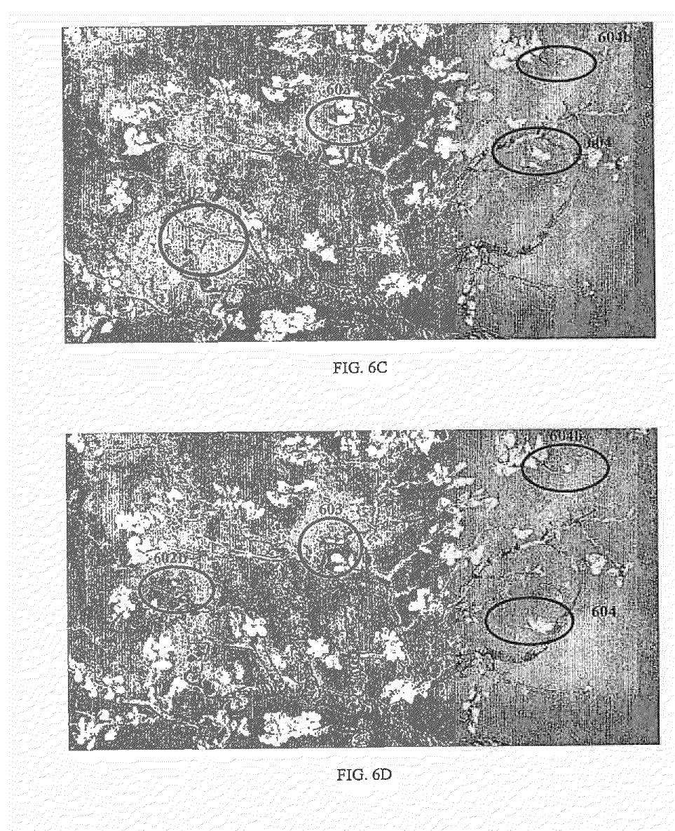

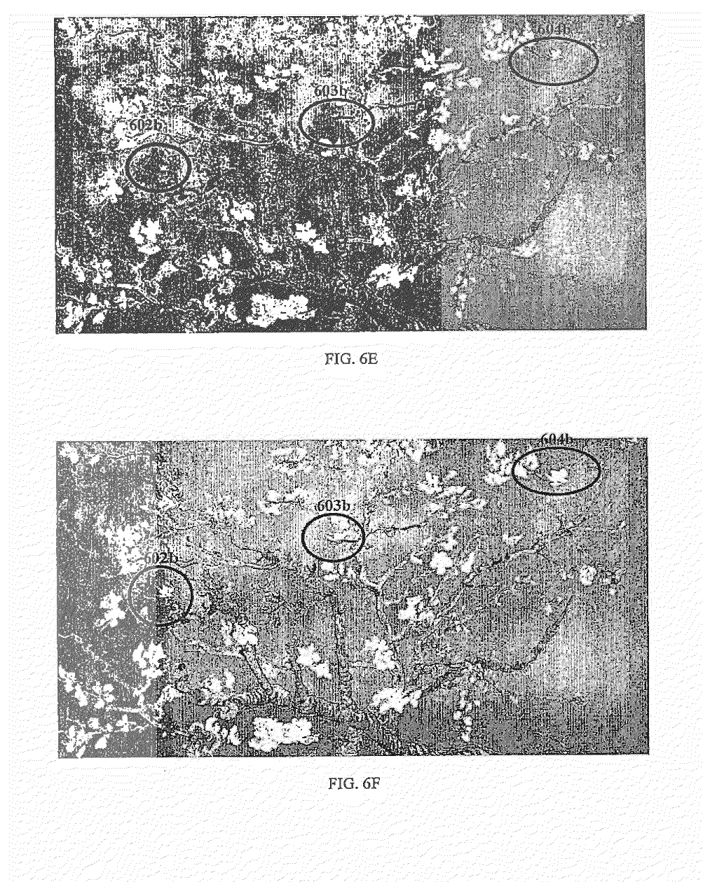

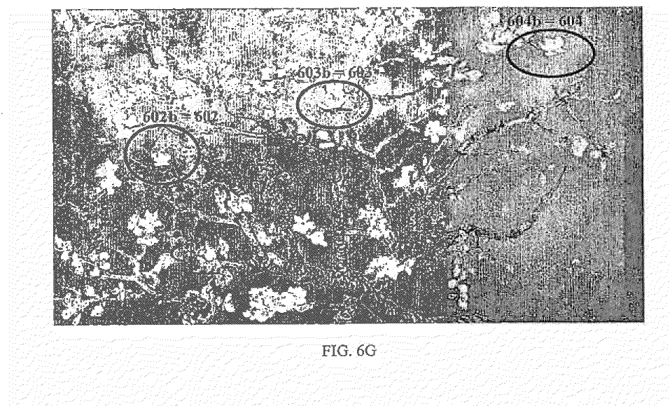

FIG. 6 illustrates in detail this process, using a painting by Vincent Van Gogh as example. Exemplarily, the painting in digital form is transformed into a video sequence of 150 frames, only six of which are shown. The “original” painting appears in the first frame, FIG. 6A and in the last frame, FIG. 6G. All other frames are “brought to life” frames of the original painting, showing movement of different objects such as flowers, leaves and branches. In the original painting, FIGS. 6A and 6G, objects 602, 603 and 604 are flowers in full bloom (full size) attached to respective branches. FIG. 6B shows frame 25, in which flowers 602 and 604 are shown falling off their respective branches, while flower 603 is still in its original place. A new bud, 604b, has appeared on the respective branch instead of flower 604. FIG. 6C shows frame 50, in which flowers 602 and 604 are falling further, flower 603 is still in its original place, and bud 604b starts to grow. In FIG. 6D, frame 80, flower 602 has disappeared, a new bud 602b has appeared on the respective branch instead of 602, flower 603 starts falling off its respective branch, flower 604 is still failing, and bud 604b is growing. In FIG. 6E, frame 100, flowers 603 and 604 have disappeared too, a new bud 603b has appeared on the respective branch instead of 603, while buds 602b and 604b develop into flowers. In FIG. 6F, frame 125, all three new buds (flowers) 602b, 603b and 604b continue to grow, until in FIG. 6G, frame 150 (which is identical with frame 1), they return exactly to the shape and size of original flowers 602, 603 and 604. Consequently, when the video sequence is repeated again and again, the visual effect created is of the painting being “brought-to-life” in an endless loop. Note that in some cases, there is no need to have two identical first and last frames, but only a need that the one frame before last (149 in this example) lead naturally back to the last frame such that the transformation (merging) between sequences is smooth, with no cut.

Alternatively, multiple sequences can be created, such that in each sequence only one or more of the frame parts move. For example, one sequence can show flower 602 falling off its respective branches, new bud, 602b appearing on the respective branch instead of flower 602, bud 602b starting to grow, and developing into a flower, until it reaches exactly the shape and size of original flower 604. Another sequence can show a similar process for flower 603 and bud 603b, and yet another sequence can show a similar process for flower 604 and bud 604b. In each of the sequences the last frame is identical to the first frame, or is transformed seamlessly to the first frame.

The sequences can be played in a random order, wherein after playing one sequence, another sequence is randomly selected from the available sequences. Since in each of the sequences the last frame leads seamlessly to the first frame, the sequences when played in a random order provide a spectator with a feeling of a continuously moving live picture.

Alternatively, the sequences can be played in a constant order. This option is particularly useful if there are a large number of different sequences, so as to make the sequence look more natural and less expected.

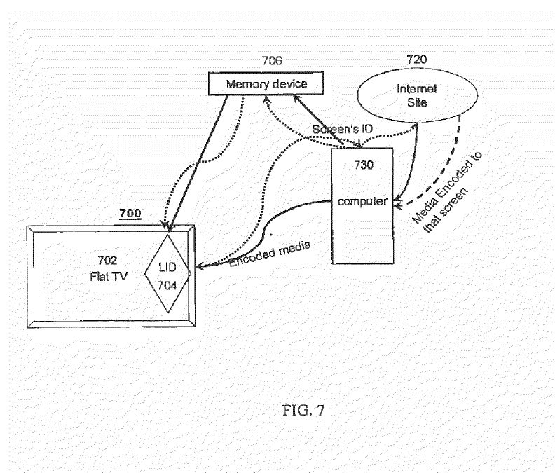

FIG. 7 shows an embodiment of a system 700 that can be used in the preparation and presentation of the live art images or filmed video sequences in an infinite loop. System 700 includes a TV screen 702 for exhibiting the live art. Included in screen 702 is a player 704 (called here a “Live Images Device” or LID) that performs actions described above and in particular is configured fir playing an infinite loop. The integration or coupling between the player and the screen may be done in various ways well known in the art. Optionally, system 700 may include a memory device 706 for storing the digital artwork or live images. Memory device 706 may be detachable or integral to screen 702.

In use, internal LID 704 may already include at least one internal “live image” sequence. In case a user wishes to add or replace “live images” on LID 704, he/she can obtain such images from memory device 706 or from another source such as an Internet site 720 to which LID 704 is operationally connected. Memory device 706 may already store numeric “live images” or be connectable to a computer 730 through which it can download the live images from the Internet.

In case a user wishes to download from the Internet a digital art work that is protected (for a “one-of-a kind” exhibit on the screen), this may be done in two ways:
a) Using memory device 706. Device 706 is connected to computer 730. Internet site 720 will request an ID of LID 704 or serial number of screen 702 and then export to the memory device decoded art media suitable for playing only on the specific LID 704. Alternatively, the Internet site will request an ID or serial number of screen 702 and export encoded media to LID 704, which will then decode the encoded art media.
b) Using a connection between LID 704 and the Internet site directly or through computer 730. The internet site will request an ID of LID 704 or serial number of screen 702 and then export to LID 704 decoded art media. Alternatively, the Internet site will request an ID or serial number of screen 702 and export encoded art media to the LID 704, which will then decode the encoded art media.

While the disclosure has been described with respect to a limited number of embodiments, it will be appreciated that many variations, modifications and other applications of the disclosure may be made. What has been described above is merely illustrative of the application of the principles of the present disclosure. Those skilled in the art can implement other arrangements and methods without departing from the spirit and scope of the present disclosure. In addition, citation or identification of any reference in this application shall not be construed as an admission that such reference is available as prior art to the present disclosure.

What is claimed is:

1. A method of displaying content on a display device, the method comprising:
obtaining at least one sequence of frames having a first frame and a last frames in which a transformation between the last frame and the first frame is seamless; and
repeatedly displaying one of the at least one sequence of frames on the display device.

2. The method of claim 1 wherein the at least one sequence of frames is encoded with a unique identifier associated with the display device or with a player associated with the display, device.

3. The method of claim 2 wherein the at least one sequence of frames can be displayed only on the display device associated with the unique identifier.

4. The method of claim 1, wherein the first frame and the last frame of the video sequence are substantially identical.

5. The method of claim 1 wherein the transformation between the frame before the last frame and the last frame leads to the transformation between the last frame and the first frame.

6. The method of claim 1 further comprising a step of creating the sequence of frames.

7. The method of claim 6 wherein creating the at least one sequence of frames comprises:
receiving an image; and
creating the sequence of frames such that at least one object or at least one part of the image changes between images of the at least one sequence of frames.

8. The method of claim 6 wherein creating the at least one sequence of frames comprises filming by a static camera.

9. The method of claim 6 wherein creating the at least one sequence of frames comprises filming by a dynamic camera or a camera using a dynamic frame size.

10. The method of claim 9 wherein the transformation is made seamless by using a quick camera movement.

11. The method of claim 6 wherein creating the at least one sequence of frames comprises:
filming a basic sequence of frames comprising at least one shot having a first frame and a last frame;
digitizing the at least one shots and
editing the at least one shot to obtain an effect of seamless transformation between the last frame and the first frame, to obtain the at least one sequence of frames.

12. The method of claim 11 wherein editing the at least one shot comprises:
duplicating the at least one shot to obtain a duplicated shots and
merging the end of the at least one shot with the beginning of the duplicated shot.

13. The method of claim 12 wherein merging the end of the at least one shot with the beginning of the duplicated shot is performed using at least one technique selected from the group consisting of: adding a transition effect; adding a masked wipe effect; adding animated frames between the end of the at least one shot with the beginning of the duplicated shot; adding another layer of video; and adding a dissolve effect.

14. The method of claim 1 wherein the at least one sequence of frames comprises at least two sequences of frames.

15. The method of claim 14 further comprising a step of selecting a random sequence of frames from the at least two sequences of frames and displaying the random sequence of frames.

16. A system for displaying content on a display device, comprising:
a display device; and
a player operatively coupled to the display device and adapted to repeatedly play at least one sequence of frames.

17. The system of claim 16 wherein the at least one sequence of frames is created such that the last frame is seamlessly transformed to the first frame.

18. The system of claim 16 wherein the at least one sequence of frames comprises at least two sequences of frames, and wherein the player is adapted to randomly select a sequence of frames to be displayed from the at least two sequences of frames.

19. The system of claim 16 wherein the player is adapted to play the at least one sequence of frames, provided that the at least one sequence of frame has encoded therein a unique identifier associated with the player or with the display device.

20. The system of claim 16 further comprising a storage device for storing the sequence of frames.
